(19) United States
(12) Patent Application Publication
(10) Pub. No.: US 2004/0100090 A1
(43) Pub. Date: May 27, 2004

(54) Security device

(76) Inventors: Sharon Christine Davis, Hampshire (GB); Jacqui Louise Thick, Hampshire (GB); Graham Webb, Hertfordshire (GB)

Correspondence Address: Oliff & Berridge, PO Box 19928, Alexandria, VA, 22320, US

(21) Appl. No.: 10/257,541

(22) PCT Filed: Apr. 17, 2001
(86) PCT No.: PCT/GB01/01744

(30) Foreign Application Priority Data
Apr. 17, 2000 (GB) 009474.8

(51) Int. Cl. B42D 15/00

(52) U.S. Cl. 283/91

(57) ABSTRACT

A security device comprising a plurality of sets of nested line segments, each set comprising a plurality of line segments (52) which are specularly reflective or have a specularly reflective component formed as a relief structure in or on a surface, the sides (70) of the line segments extending at angles offset from the normal to the surface. When the line segments (52) are exposed to a light beam in an exposure direction, an image is generated different from the appearance of the line segments when viewed under different illumination conditions.

Documents which have a high intrinsic value, such as banknotes, usually contain several security features to prevent or minimise production of counterfeits. This patent relates to security features which prevent or deter counterfeiting by use of a photocopier or other computer used with colour scanning and printing devices.

One class of security features depend upon specialised, and not generally available, production processes which provide an easily recognisable and distinct effect. A hologram is a well known example of such a feature. Holograms and other features which rely on the diffraction of light require special production techniques because of the fine resolution of the structures. Such techniques increase the cost of production.

Other examples, such as U.S. Pat. No. 5,772,248, use a relief structure to provide an observer with an image which changes or disappears according to the angle at which the document is viewed. Although such features can be effective in preventing counterfeiting, they are also expensive to produce.

Easy access to office photocopiers and, more recently, personal computers with connection to colour scanners and printers means that high value documents must include features which prevent or deter electronic copying. Using common personal computer configurations it is easy to scan a document and then print the document. It is also easy, using readily available software, to carry out some retouch and improvement operations prior to printing.

Currently available photocopiers convert a document, or other original, into an electronically digitised image using well-known principles which are similar to reflection colour scanners connected to personal computers.

In typical and well known examples of copiers and scanners, an original is placed, face down, on a transparent platen. A scanning head, which consists of a light source and detector array, then scans along the original. The light source is commonly a fluorescent tube arranged to illuminate a thin line of the original at an angle which is oblique to the surface of the original. A line of the original, typically about 85 μm wide, is then imaged onto a detector, which is commonly a linear array of photosensitive elements known as a CCD (charge coupled device). The detector is usually arranged to detect light which is reflected normally to the document surface. As the scanning head moves along the platen, successive lines of the original are digitised and read into a computer memory. By this means a rectangular array of pixels representing the original document is formed in the computer memory.

It should be noted that, for colour scanners, it is common to use three closely spaced lines of detectors, forming three CCDs, each covered by a filter so that each line of detectors is receptive to a different one of the three primary colours red, green and blue. Data processing functions ensure that the three colours stored in the computer memory are mutually aligned. This arrangement of detectors has no significant effect on the invention described.

Other arrangements of optics and mechanics are also possible and known.

Scanners and copiers of the type described are designed to digitise documents or pictures (and other material) which do not contain security features and which are intended for easy viewing under normal ambient lighting conditions. The nature of such documents is that they reflect incident ambient light diffusely. Any significant surface gloss, normally referred to as specular reflection, usually detracts from the appearance of the document. The arrangement of the light source and detector in a typical reflection scanner as described ensures that only diffuse light is collected by the CCD detector. The digitized image formed in the memory is therefore a good likeness of a diffusely reflecting original. The orientation, on the scanning platen, of a document which reflects diffusely is also not critical. It will however become fully apparent later, when describing this invention in detail, that the scanning optical arrangement is not symmetrical along the two major axes of scanning, particularly for originals which are not diffusely reflecting.

It is known that any specularly reflecting element such as a metallic thread in a banknote will produce a black image when scanned because no light is diffusely reflected onto the CCD detector. The effect is also apparent in older copying machines which image an original directly onto an electrostatic drum. U.S. Pat. No. 4,303,307 describes a reflective coating which produces a black result when copied on such a machine. Not only is this special coating an extra cost but the effect of such a coating over the whole document gives an undesirable appearance.

U.S. Pat. No. 4,066,280 describes a method of producing two overlapping patterns, one pattern being printed using a conventional ink and the other pattern being produced in a specularly reflecting ink. A copier reproduces the two patterns differently and hence obvious pattern may be reproduced. The effectiveness of this system is limited because the specular surface is essentially flat on the secure document. The advantages of the current invention over this prior art will become apparent later.

European patent EP0377167 shows how light deflecting structures may be used to cause light to be spuriously incident on a part of an electrostatic drum which should be imaging another part of the original. The optical arrangement of a CCD scanning device, as will become apparent later, has an optical system which is not affected in the same manner by this type of copy prevention.

A common objective of a feature designed to prevent copying is to produce a pattern or image on the copy which is not readily detectable in the original. Systems of lines printed on the secure document which interact with the digital image sampling are known to produce such effects on some copiers. However such features exploit the relatively low spatial sampling rates of about 200 pixels per inch which were common on early digital copiers. Typical copiers and scanners currently available work at 300 or 400 pixels per inch and often higher. Because the exact resolution of scanning may not be known on a scanner connected to a personal computer and also because of limitations of optical resolution, the effectiveness of such line patterns interacting with pixel sampling is considerably reduced on newer equipment.

Other known means to deter copying rely on producing line patterns which include lines sufficiently thin that they are not well produced on low resolution copiers. U.S. Pat. No. 5,788,285 describes patterns of continuous and broken lines in which the different lines are reproduced differently on a copy, leaving the continuous lines to show a message, commonly called a latent image. These types of pattern are less effective on scanners operating at higher resolutions and may be visible on the original under some viewing angles.

Yet another example of a feature to deter counterfeiting using copiers or scanners is given in U.S. Pat. No. 5,722,693. This patent discloses a method of printing two line structures and then embossing over one structure. Although such a technique is less dependent on scanner or copier resolution, the usefulness on a typical scanner will vary significantly according to the orientation angle at which the original secure document is placed on the platen. There is also a requirement to emboss in register over printed lines and such a requirement is not easy to achieve in practice.

GB-A-2241668 illustrates a security device including a latent or transient image which is only visible under normal viewing conditions from certain angles. This is intended to enable documents to be authenticated.

U.S. Pat. No. 5,403,040 discloses an optically variable device which relies on diffraction effects and thus highly complex printing machinery to achieve it.

U.S. Pat. No. 4,420,515 discloses a process using a transfer agent which transfers metal particles onto varnished areas of a document which is then embossed. A latent image is formed.

In accordance with the present invention, a security device comprises a plurality of sets of nested line segments, each set comprising a plurality of line segments which are specularly reflective or have a specularly reflective component formed as a relief structure in or on a surface, the sides of the line segments extending at angles offset from the normal to the surface, wherein when the line segments are exposed to a light beam, an image is generated different from the appearance of the line segments when viewed under different illumination conditions.

The “different illumination conditions” will typically be those under which the device is usually viewed, for example ambient light or diffuse light.

The present invention overcomes the limitations of the prior art with an inexpensive means to deter copying by producing a clear spurious copy or image on a wide range of copiers/scanners. A pattern will be produced independently of the type of copier or scanner used over a wide range of resolutions. The device does not rely on diffractive effects to achieve the effect and can thus be provided by conventional printing and embossing techniques. Preferably the segments are arranged so that a distinct pattern is formed and seen when the document is illuminated at 45 degrees and viewed normally as in a scanner. The distinct pattern is not visible under diffuse illumination and is not any explicit or implicit part of the design.

The device is preferably constructed such that under diffuse lighting conditions the device presents substantially the same appearance from all viewing directions, but when the line segments are exposed to a light beam in an exposure direction, an image is generated different from the appearance of the device under diffuse lighting conditions.

Typically, the line segments will be embossed in the reflective surface although they could be moulded or printed with a reflective ink, coating or other material or provided in other well known methods with a reflective ink, coating or other material. An intaglio screening element may or may not be incorporated into the mould or engraving to give added structure to the line segments. The term “relief structure” is intended to include structures formed in the surface of the substrate for example embossed, indented or impressed, as well as on or in part of the surface as a raised structure.

Preferably, the line segments of each set define similar shapes which are typically similarly oriented with respect to each other.

The term “line segment” generally means a continuous line but could also include very short “lines” such as dots. The line segments may take a variety of forms and could be open ended but in preferred examples define closed loci such as regular geometric shapes including multifaceted shapes such as octagons and dodecahedra or in the most preferred example curves such as circles. Furthermore, random blocks of lines could be provided, the blocks having any shape such as triangles, checkerboard, etc.

The spacing between line segments should be minimized and is ideally zero although in practice with standard printing techniques such as intaglio printing or embossing techniques, there will usually be spaces between the lines.

The lines in each segment are preferably spaced as closely as allowed by practical production processes in order to maximise the observed effect.

The line width is preferably in the range 10-250 μm with a space between lines of 25 μm or less.

Preferably, the sides of at least 25%, more preferably at least 50%, typically at least 75%, most preferably 100% of the line segments extend at 10-45°, preferably 15-25°, more preferably 20-23° and ideally 22.5° to the plane of the surface. In some cases, the sides of the line segments present a range of angles, for example curved, so that the device is effective on a range of scanners and tolerant to production variations.

The relative orientation of the line segments is preferably chosen to maximise the effect when scanning as will be described in more detail below.

The specularly reflective surface may be defined by a metallic ink or metallic foil.

Security devices according to the invention can be used to secure a variety of items but are particularly useful with security documents such as banknotes, identification cards, credit cards, cheques, bonds, certificates, brand protection applications, stamps, passports, security foils, certificates of authenticity, and secure packaging. In particular, it will be noted that the device can be printed directly on the document.

In order to avoid counterfeiting by stepping and repeating a single set, the repeat element between sets can be varied by varying the size and/or shape of each set and/or the line width and line spacing while retaining optimum line width/spacing ratios and line width/depth ratios. The sets may be repeated at a number of random positions on the document or may be repeated to form a recognisable pattern or frieze effect. There may be some variation in the shape or size of the sets and a combination of different nest designs may be used.

An area of the specularly reflective surface can be left flat or planar within the design.

The specularly reflecting surface may be any colour, for example silver or gold. When specularly reflecting inks are used, the general appearance of such inks, which are not as highly reflecting as specular mirror surfaces, is a distinctive sheen.

When an attempt is made to reproduce the security device by scanning or printing, a new and more obvious pattern is produced. In the case of a set of nested circular line segments, this pattern has a distinctive cone-shaped appearance. The new pattern is not easily detected on the original document by observation under normal ambient lighting conditions and may be independent of the scanning resolution and largely independent of orientation of the original on the scanner or copier platen.

Typically, the line segments are provided at a frequency of less than 10 lines/millimetre so that they can be produced by embossing using an intaglio or similar printing process or die stamping. The use of standard printing processes obviates the need for expensive processes which are necessary for finer structures which achieve an effect by diffracting light.

The process is inexpensive, particularly when using inks, since no special foils or other items are attached to the document to be protected and no exact registration is required between the printed ink and the embossing.

Some examples of security devices according to the invention will now be described with reference to the accompanying drawings, in which:

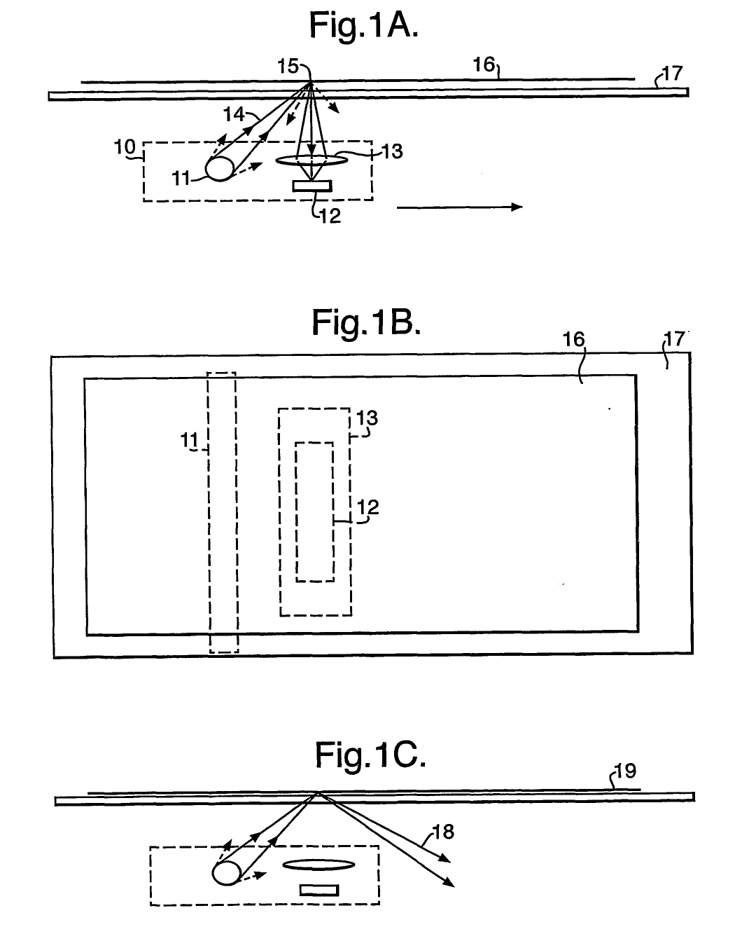

FIGS. 1A-1C illustrate schematically a side view, plan and side view respectively of a conventional scanner, FIG. 1A illustrating the scanning of a diffusely reflecting original and FIG. 1C illustrating the scanning of a specularly reflecting original;

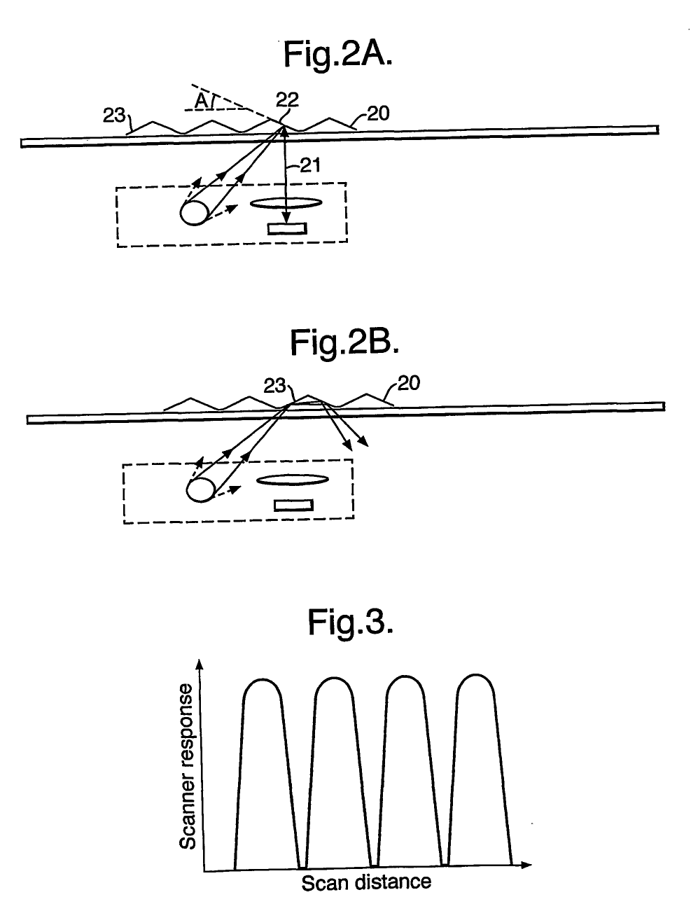

FIGS. 2A and 2B are views similar to FIG. 1A but showing the scanning of an example of a security device according to the invention;

FIG. 3 shows the digitized response of a typical scanner to an embossed specularly reflecting surface aligned across the platen as the scanner scans across the pattern;

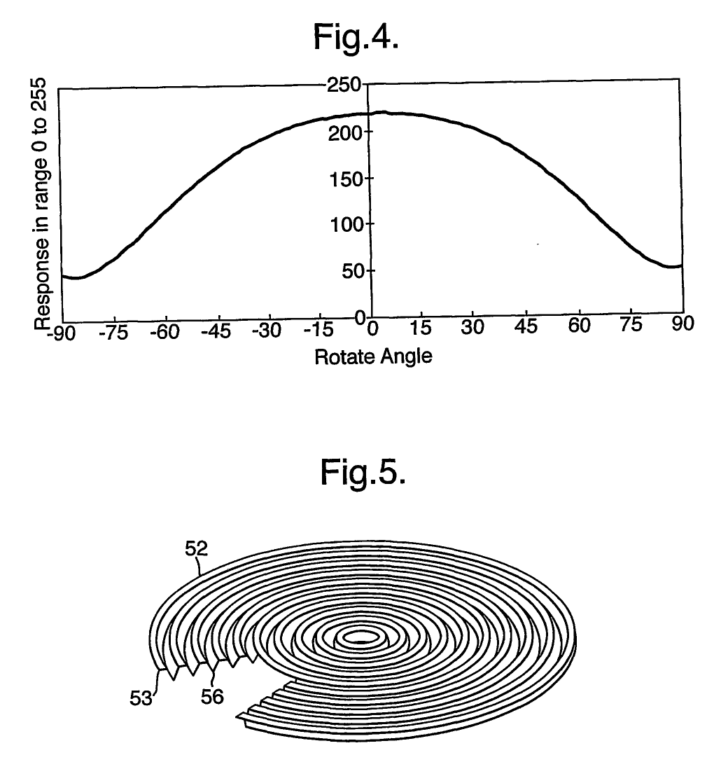

FIG. 4 shows the peak response of the scanner to an embossed structure in a specularly reflecting surface placed at different orientations on the scanner platen;

FIG. 5 shows a simple circular embossed pattern;

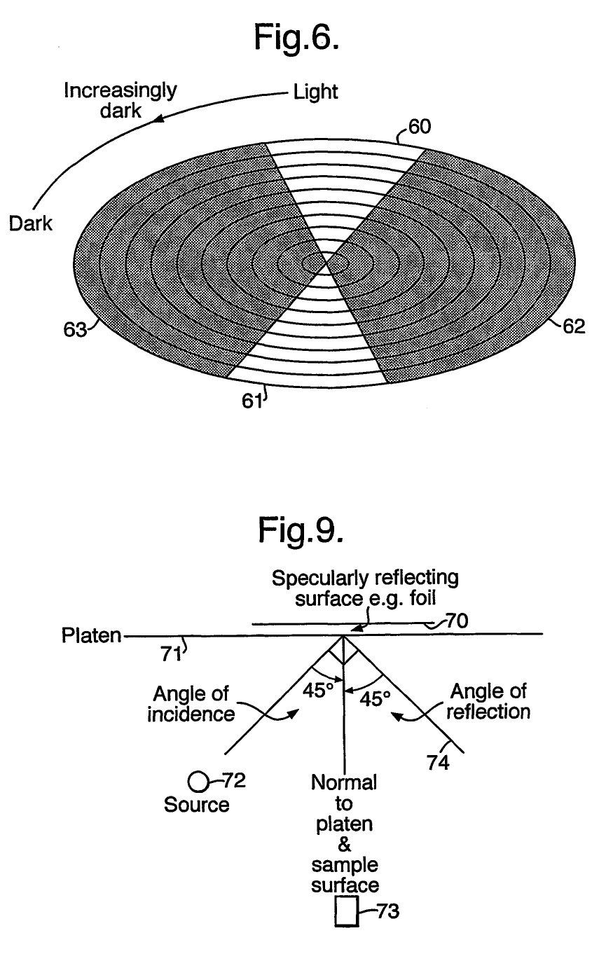

FIG. 6 shows, diagrammatically, the result of scanning and reproducing the pattern of FIG. 5A;

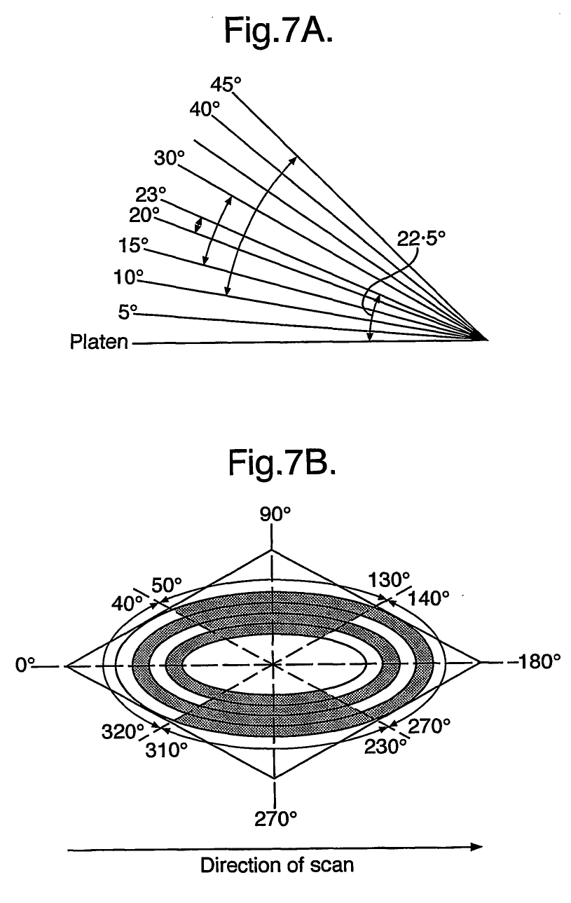

FIGS. 7A and 7B illustrate the principles of the invention in more detail;

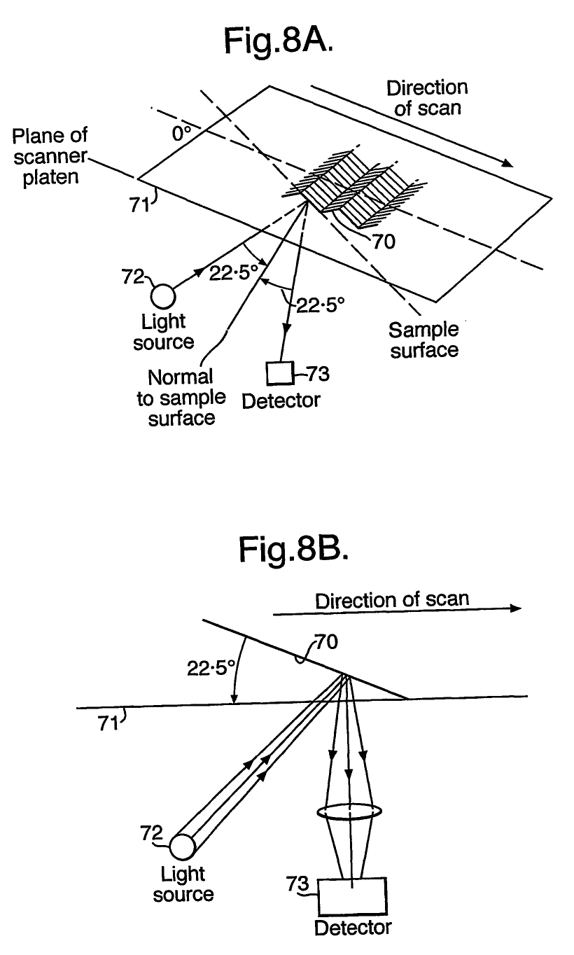

FIGS. 8A and 8B illustrate schematically operation of the invention on a scanner;

FIG. 9 illustrates the effect of a flat specularly reflecting surface on a scanner;

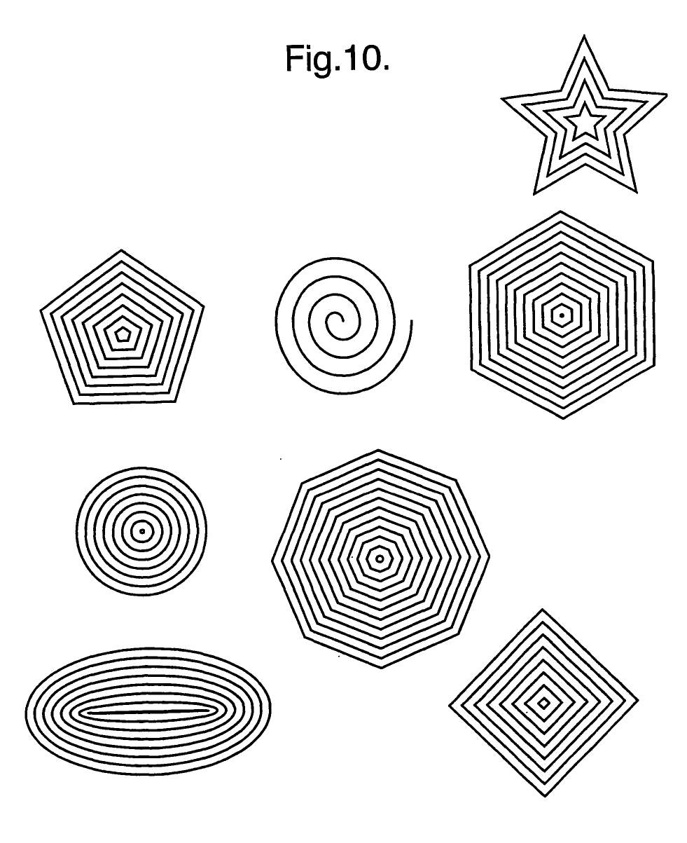

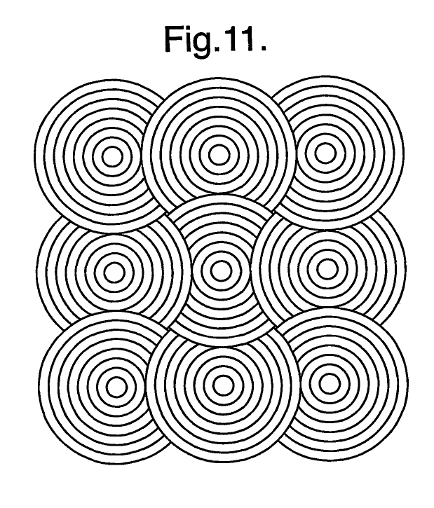

FIG. 10 illustrates a variety of sets of line segments which can be used to design security devices according to the invention;

FIG. 11 illustrates an example of a further security device according to the invention;

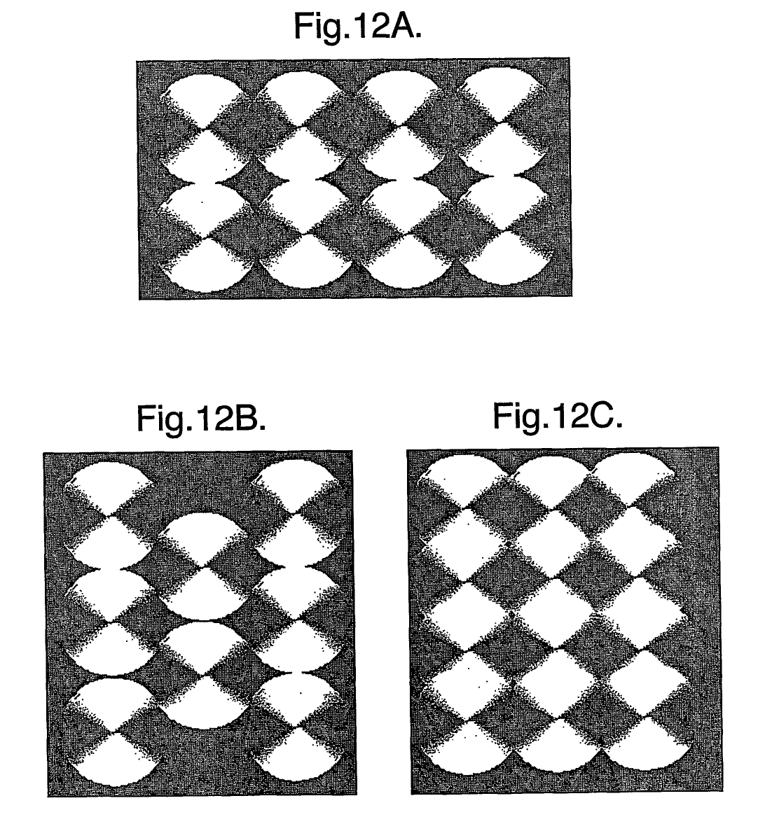

FIGS. 12A-12C illustrate the effect of scanning security devices according to the invention;

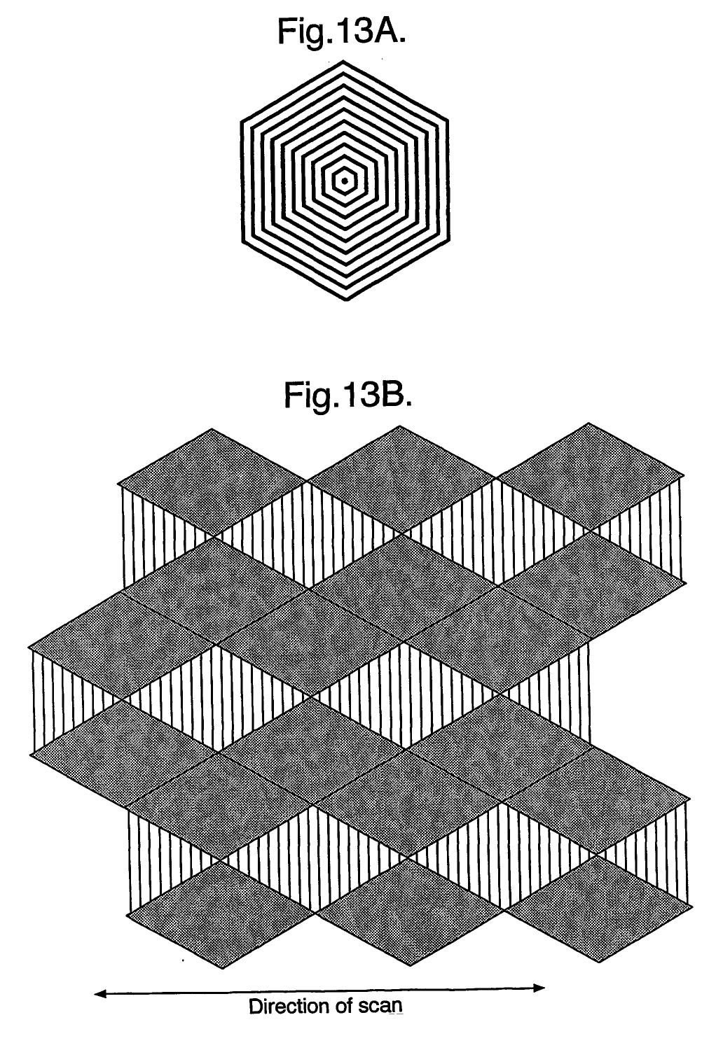

FIGS. 13A and 13B illustrate a typical example of a security device according to the invention and the general result of scanning an array of such security devices respectively; and

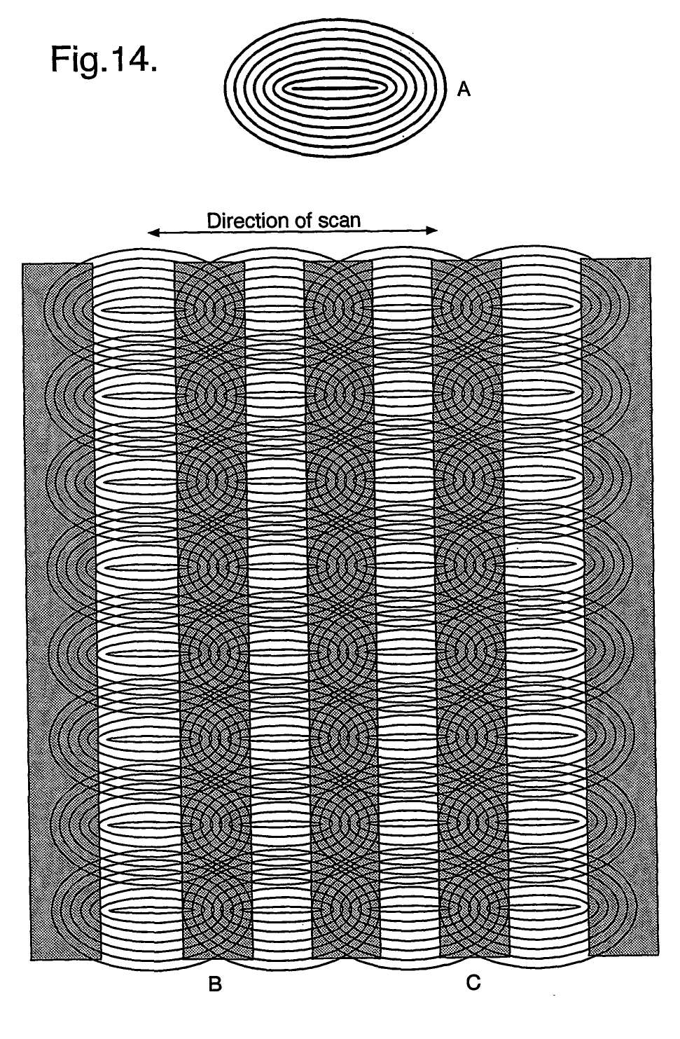

FIGS. 14A and 14B are views similar to FIGS. 13A and 13B respectively but of a second security device.

Documents which include the printing and embossing method described cannot be accurately copied on a photocopier or scanner system. In order to understand in detail how the invention prevents copying, the optical arrangement of a typical commercially available flatbed scanner will now be described.

FIG. 1A shows a side elevation of the important parts of the optical arrangement commonly used in most flatbed scanners. A diffusely reflective original, 16, such as a paper sheet, carrying an image to be copied is placed face down on a transparent platen, 17. Optical carriage, 10, contains a light source, 11, a lens 13, and a CCD detector 12.

Light source, 11, is usually a type of fluorescent tube with an approximately white emission spectrum. Light, 14, illuminates an area, 15, of the original and diffusely reflected light is collected by lens, 13, and focussed on to CCD 12. FIG. 1B shows a plan view of the scanner with platen 17, original 16, light source 11, lens 13 and CCD 12. It will be appreciated that a line of the original is illuminated by the light source and focussed onto the CCD, which is a linear array of receptors. During operation, the signal resulting from light, which is diffusely reflected from the original, impinging on each detector is transferred from each receptor to the computer memory by techniques which are well known in the art of scanner design. Data is read from the CCD at a comparatively high rate, for example 5000 elements of the array may be read out in 10 milliseconds. Many speeds are possible but do not affect the operation of this invention. The carriage 10 moves slowly along the original causing successive lines which are read from the CCD to represent successive linear portions of the original. By this means an original is digitised into an array of pixels. In some scanners and copiers, the speed at which the carriage is moved is varied in order to alter the resolution or size of each pixel which is digitized. This invention is independent of the scanning resolution and hence has an advantage over anti-counterfeit systems which rely on interaction between a specific pattern and the resolution of the scanning device.

Baffles are normally provided to ensure that stray light reaching the detector is minimised. The platen dimensions are typically 310 mm by 220 mm, or approximately European size A4, but other sizes are possible. Other variations are known in which mirrors are inserted in the light path or a second light source is used but these variations do not significantly affect the invention.

Reflection scanners are designed to maximise diffusely reflected light arriving at the detector and avoid direct reflection of light onto the detector. Hence the illumination angle is usually about 45 degrees to the platen surface and collected light is at 90 degrees to the surface. This criteria is also applied to other types of scanner which may have a very compact arrangement of the lens and CCD system. In some systems the lens are fabricated as a part of the CCD device. As stated in the introduction, the CCD may consist of 3 adjacent lines of CCD's, each line being receptive to a single primary colour. The effect of using three CCD's on the angle at which diffuse light is collected is very small and does not affect the invention in any material way.

FIG. 1C shows the result of placing a specularly reflecting original 19 on the platen of a scanner as previously described. Light from the light source is reflected along path 18 and does not reach the CCD. Thus either no signal or a very small signal is digitized in this condition.

FIG. 2A shows the effect of placing an embossed original 20 on the platen and scanning. The scanning head is shown at a position where light impinges on surface 22 of the original and where surface 22 is imaged onto the CCD. Because the surface 22 is at an angle to the platen, light is reflected along path 21 onto the CCD and a significant signal is digitised. Surface 22 is at angle A to the platen as shown in FIG. 2A. Angle A is approximately 22.5 degrees for maximum response on many scanners but light source 11 is not a point source and hence the precise angle of the embossed surface 22 is not critical. Angles between about 15 and 25 degrees are preferable. Any of the surfaces which are approximately parallel to surface 22 provide a significant response.

FIG. 2B shows the scan head in a position to image surface 23 onto the CCD. Light which impinges on surface 23 is deflected away from the CCD and produces a lower response than a non-angled surface such as surface 19 shown in FIG. 1C. FIG. 2B shows the light incident such that internal reflection occurs within both surfaces, 22 and 23, of the embossing. It will be appreciated that the light source is not a point source and that the embossed surface may not be precisely as shown in FIG. 2. It will also be appreciated that the surface printed with specularly reflecting ink will not reflect all of the incident light in a specular manner. Some light will be absorbed and some will be reflected diffusely. Embossed surfaces which are generally sloping towards the light source, like surface 22, will increase the amount of light falling on the detector whereas surfaces which slope away from the detector, like surface 23; will reduce the amount of light falling on the detector. Consequently, as the scan head scans over the embossed original 20, the response will vary approximately as shown in FIG. 3.

The dimensions of the embossing are not critical but widths of each channel from 50 μm to 250 μm provide useful results. The depth and shape of the embossing are not critical but preferably the elevation to the substrate surface is such that a significant proportion is at 15-25° to the surface of the platen of a copier in use. Surface 23 should be arranged symmetrically, that is at a complementary angle, to surface 22 so that rotation of the feature by 180 degrees produces the same result.

In the previous description, the embossing has been assumed to be aligned across the platen. If the document containing the grooves is rotated on the platen by 90 degrees, then light which is incident on either surface 22 or 23 will be reflected so that it does not fall on the CCD detector. FIG. 4 shows the response of a scanner to a single embossing at various intermediate angles of rotation. Embossed lines across the platen will always produce a significant response but embossed lines along the platen will always produce a low response.

It will be appreciated that the structure shown may be produced by forming an embossing or by using an embossed printing plate to form cavities in the surface of the specularly reflecting ink. In either case the resulting scanner response will be similar.

In this invention, patterns are designed which have embossing in various directions, including mutually perpendicular directions. When viewed normally this produces a faint pattern but, when scanned, a different bold pattern appears even if the document is rotated on the platen, defocussed, or tilted on the platen.

FIG. 5 illustrates schematically a circular pattern in which a reflective surface 52 has been embossed with nested circular grooves 56 separated by flats 53. The appearance of this security device on scanning is shown in FIG. 6 where it will be seen that it exhibits relatively light regions 60, 61 and relatively dark regions 62,63. The transition from light to dark may be gradual.

FIG. 11 illustrates a security device defined by a number of overlapping sets of nested circles with each white ring representing an embossed groove. The spacing of the centre of the circles is \sqrt{2}×radius. The effect of scanning the device shown in FIG. 11 is shown in FIG. 12C. FIGS. 12A and 12B illustrate the results of scanning non-overlapping circular patterns.

FIG. 13A illustrates a nested hexagonal component while FIG. 13B illustrates the effect of scanning an array of the components shown in FIG. 13A. As can be seen, this leads to a distinctive light and dark pattern.

FIGS. 14A and 14B are similar to FIGS. 13A and 13B respectively, the security device assembly generating FIG. 14B being formed by overlapping versions of the nested, elliptical line segments component of FIG. 14A. The areas shown shaded in FIG. 14B will appear light on scanning.

It will be noted that all these devices achieve an anticopy effect independent of orientation.

The principles behind the invention will now be described in more detail.

A surface which forms part of the pattern may at any point be described geometrically by two angles; the angle of elevation above the platen, shown in FIG. 7A, and the angle of rotation relative to the platen shown in FIG. 7B. The two angles of the surface, together with its reflectance, determine the amount of light detected by the scanner.

FIG. 9 illustrates the effect of a specularly reflecting plane surface, 70, on the platen 71. That is, its angles of elevation and rotation can both be considered to be zero. Thus light incident at 45 degrees from light source, 72, is reflected away from the detector, 73, in the direction 74. If the surface is angled then the light beam is rotated through an angle equal to twice the angle of elevation of the surface as shown in FIG. 8B. FIG. 8B shows the surface at an elevation of approximately 45/2=22.5 degrees reflecting light onto the detector 73. FIG. 8A shows a relief structure in which surfaces are alternately angled towards and away from the light source. The surfaces which are angled away from the light source will reflect no light onto the detector. Whereas a specularly reflecting surface of the type shown in FIG. 8A will appear bright when viewed in normal lighting by an observer, the response of the scanner will be light and dark bands corresponding to the angles of the surface. Thus the pattern reproduced by the scanner differs from the pattern seen by an observer.

The angle of elevation above the plane of the platen is preferably in the range 20-23° to obtain maximum light reflection to the detector although a range of 15-30° will give a reasonable effect and even a range of 10-45° is satisfactory in some cases. Angles above the platen of less than 5° will not reflect much light regardless of the rotation angle.

The effect of angle of rotation is demonstrated with a circular pattern similar to that shown in FIG. 5, in FIG. 7B. Maximum light response is obtained at 0° or 180° depending on the direction of scan while minimum light response at the detector is obtained at 90° and 270°. The use of a circle is preferable because this will show a contrasting effect when scanned in any direction.

The most preferred angle of elevation of the groove slope is 22.5° (if the light source is angled at 45° to the normal of the platen) above the platen and angled at 0° to the scanner as shown in FIGS. 8A and 8B. This is because nominally the light from the light source is constrained and hits the sample slope at 45° dependent on the scanner type.

In this invention, a second pattern becomes apparent and overrides the embossed circles to demonstrate a diamond pattern or “bow-tie” in a single set of nested concentric circles.

In preferred examples, intaglio (embossed) line widths (min 10 μm-max 250 μm), line depths (min 10 μm-max 150 μm), and pitch (min 20 lines/cm-max 1000 lines/cm) are used.

In theory, when we require only a bright/light reflection back to the detector we do not want spaces between those lines which would reflect in the same way as a normal flat specularly reflecting surface, i.e, reflecting light away from the detector showing up as dark or black. This would therefore reduce the visual intensity of the bright reflecting angles of the lines.

In practice, it was found that using the standard photographic origination techniques of such designs, a space had to be defined to allow the design to be produced.

FIG. 10 illustrates a variety of nested arrays from which security devices according to the invention can be designed. In practice these devices will be repeated adjacent or even overlapping one another. Each array in FIG. 10 comprises a nested set of line segments and these sets may be repeated in different relative orientations or with variations in line widths/spacings. When these arrays are provided in groups of two or more (usually of the same design but optionally of different designs) a visible pattern becomes readily visible when they are scanned.

The maximum lateral dimension of each set is typically in the range 2-20 mm with the preferred dimension 3-7 mm, particularly 5 mm.

Typically, the number of sets in the device will be in the range 9 to 100, usually arranged in a compact array e.g. 3×3 or 10×10.

In some cases, the embossed line segments may extend into non-specularly reflective areas of the substrate.

1. A security device comprising a plurality of sets of nested line segments, each set comprising a plurality of line segments which are specularly reflective of have a structure in or on a surface, the sides of the line surface, wherein when the line segments are exposed to a light beam, an image is generated different from the appearance of the line segments when viewed under different illumination conditions.

2. A device according to claim 1, wherein the line segments are embossed in a specularly reflective surface or a surface with a specularly reflective component.

3. A device according to claim 1, wherein the line segments are printed on the surface with a specularly reflective ink.

4. A device according to claim 3, wherein the line segments are intaglio printed.

5. A device according to any of the preceding claims, wherein under diffuse lighting conditions the device presents substantially the same appearance from all viewing directions, but when the line segments are exposed to a light beam in an exposure direction, an image is generated different from the appearance of the device under diffuse lighting conditions.

6. A device according to any of the preceding claims, wherein the sets are substantially the same.

7. A device according to claim 6, wherein the sets are not circularly symmetric and are oriented in mutually different directions.

8. A device according to any of the preceding claims, wherein the line segments of each set define closed loci.

9. A device according to claim 8, wherein the line segments of each set define one or more regular geometric shapes.

10. A device according to claim 9, wherein the line segments of each set define curves, for example circles.

11. A device according to any of the preceding claims, wherein the line segments of each set are arranged in a regular array.

12. A device according to any of the preceding claims, wherein at least some of the line segments of a set are arranged orthogonally to other line segments of the set.

13. A device according to any of the preceding claims, wherein the line segments have widths in the range 10-250 μm, preferably 50-200 μm.

14. A device according to any of the preceding claims, wherein the line segments are spaced apart by no more than 25 μm.

15. A device according to any of the preceding claims, wherein the specularly reflecting surface is defined by a metallic ink or metallic foil.

16. A device according to any of the preceding claims, wherein the line segments have a substantially symmetrical cross-section.

17. A device according to any of the preceding claims, wherein the sides of the line segments are substantially planar, the sides of at least some of the line segments extending at different angles to the plane of the surface.

18. A device according to claim 17, wherein the sides of at least 25%, more preferably at least 50%, typically at least 75%, most preferably 100% of the line segments extend at 10-45°, preferably 15-25°, more preferably 20-23° and ideally 22.5° to the plane of the surface.

19. A device according to any of the preceding claims, wherein the number of sets of line segments is in the range 9 to 100.

20. A security document carrying one or more security devices or being constituted by a security device according to any of the preceding claims.

21. A security document according to claim 20, the security document comprising a banknote, identification card, credit cards, cheques, bonds, certificates, brand protection applications, stamps, passports, security foils, certificates of authenticity, and secure packaging.

22. A method of securing a document against unauthorised copying comprising providing the document with a security device according to any of claims 1 to 19.
